(19) United States
(12) Patent Application Publication
(10) Pub. No.: US 2026/0288138 A1
(43) Pub. Date: Sep. 24, 2026

(54) AUTONOMOUS TRAVEL CONTROLLER, MOBILE APPARATUS, AND AUTONOMOUS TRAVEL CONTROL METHOD

(71) Applicant: Asuto TANIGUCHI, Kanagawa (JP)

(72) Inventor: Asuto TANIGUCHI, Kanagawa (JP)

(21) Appl. No.: 19/554,681

(22) Filed: Mar. 3, 2026

(30) Foreign Application Priority Data
Mar. 18, 2025 (JP) 2025-043222

(51) Int. Cl. G05D 1/229; G05D 1/248; G05D 1/644; G05D 107/70; G05D 109/10

(52) U.S. Cl. CPC G05D 1/229; G05D 1/248; G05D 1/644; G05D 2107/70; G05D 2109/10

(57) ABSTRACT

An autonomous travel controller includes circuitry to determine a position and a heading of a mobile apparatus with respect to a reference path, including line segments connecting successive waypoints; set a virtual target on the reference path based on the position of the mobile apparatus; calculate a degree of bending of the reference path at one waypoint; position the virtual target ahead of the one waypoint in a case that the degree of bending at the one waypoint is equal to or greater than a threshold; position the virtual target near the one waypoint until the mobile apparatus reaches the one waypoint in a case that the degree of bending at the one waypoint is smaller than the threshold; and control the mobile apparatus to follow the virtual target based on the position and the heading of the mobile apparatus and a position of the virtual target.

### CROSS-REFERENCE TO RELATED APPLICATIONS

This patent application is based on and claims priority pursuant to 35 U.S.C. § 119 (a) to Japanese Patent Application No. 2025-043222, filed on Mar. 18, 2025, in the Japan Patent Office, the entire disclosure of which is hereby incorporated by reference herein.

### BACKGROUND

### Technical Field

The present disclosure relates to an autonomous travel controller, a mobile apparatus, and an autonomous travel control method.

### Related Art

In facilities such as gas plants and factories, typically, a large number of pipes, meters, valves, and other equipment are installed outdoors. Technologies have been developed that enable autonomous mobile apparatuses (robots) to perform equipment inspection—such as checking liquid leakage from pipes or checking abnormal meter readings—in place of workers who otherwise patrol the site for visual inspection.

In a proposed system, an autonomous mobile apparatus autonomously travels along a designated reference path on a map while performing self-localization. In this technique, the mobile apparatus enhances its followability for a reference path by setting the path-following target point farther away when traveling along a straight line and closer when traveling along a curved line. The path-following target point is a target position used for following the reference path.

### SUMMARY

The present disclosure described herein provides an autonomous travel controller including circuitry to determine a position and a heading of a mobile apparatus with respect to a reference path. The reference path includes line segments connecting successive waypoints. The circuitry sets a virtual target on the reference path based on the position of the mobile apparatus and the reference path, calculates a degree of bending of the reference path at one waypoint of the successive waypoints, positions the virtual target ahead of the one waypoint in a case that the degree of bending at the one waypoint is equal to or greater than a threshold, positions the virtual target near the one waypoint until the mobile apparatus reaches the one waypoint in a case that the degree of bending at the one waypoint is smaller than the threshold, and controls the mobile apparatus to follow the virtual target based on the position and the heading of the mobile apparatus and a position of the virtual target.

The present disclosure described herein provides a mobile apparatus including circuitry to determine a position and a heading of the mobile apparatus with respect to a reference path. The reference path includes line segments connecting successive waypoints. The circuitry sets a virtual target on the reference path based on the position of the mobile apparatus and the reference path, calculates a degree of bending of the reference path at one waypoint of the successive waypoints, positions the virtual target ahead of the one waypoint in a case that the degree of bending at the one waypoint is equal to or greater than a threshold, positions the virtual target near the one waypoint until the mobile apparatus reaches the one waypoint in a case that the degree of bending at the one waypoint is smaller than the threshold, and controls the mobile apparatus to follow the virtual target based on the position and the heading of the mobile apparatus and a position of the virtual target.

The present disclosure described herein provides an autonomous travel control method including determining a position and a heading of a mobile apparatus with respect to a reference path. The reference path includes line segments connecting successive waypoints. The method further includes setting a virtual target on the reference path based on the position of the mobile apparatus and the reference path, calculating a degree of bending of the reference path at one waypoint of the successive waypoints, positioning the virtual target ahead of the one waypoint in a case that the degree of bending at the one waypoint is equal to or greater than a threshold, positioning the virtual target near the one waypoint until the mobile apparatus reaches the one waypoint in a case that the degree of bending at the one waypoint is smaller than the threshold, and controlling the mobile apparatus to follow the virtual target based on the position and the heading of the mobile apparatus and a position of the virtual target.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an exterior perspective view of a mobile apparatus;

FIG. 2 is a block diagram illustrating a hardware configuration of a mobile apparatus;

FIG. 3 is a block diagram illustrating a functional configuration of a mobile apparatus;

FIG. 4 is a flowchart of a process performed by a virtual target setting unit;

FIG. 5 is a diagram illustrating a method for calculating a distance along a reference path;

FIG. 6 is a diagram illustrating the calculation of the degree of bending of a reference path to a virtual target;

FIG. 7 is a flowchart of a process performed by a control unit;

FIGS. 8A to 8C are diagrams illustrating a travel control of a mobile apparatus according to a comparative example; and

FIGS. 8D and 8E are diagrams illustrating effects of a mobile apparatus according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An autonomous travel controller, a program, an autonomous travel control method, and a mobile apparatus are described in detail below with reference to the drawings.

The autonomous travel controller described below is for a mobile apparatus (mobile robot) that performs facility inspection-such as checking liquid leakage from a pipe or checking abnormal meter readings while autonomously traveling in a facility such as a gas plant or a factory. Specifically, the mobile apparatus described below is an autonomous mobile robot that follows a path (reference path) set by the user and has a spot turn function, and the reference path includes a turn, for example, in a narrow path. The mobile apparatus sets a virtual target (virtual waypoint) on the reference path and follows the virtual targets in order to travel smoothly along the reference path with high accuracy.

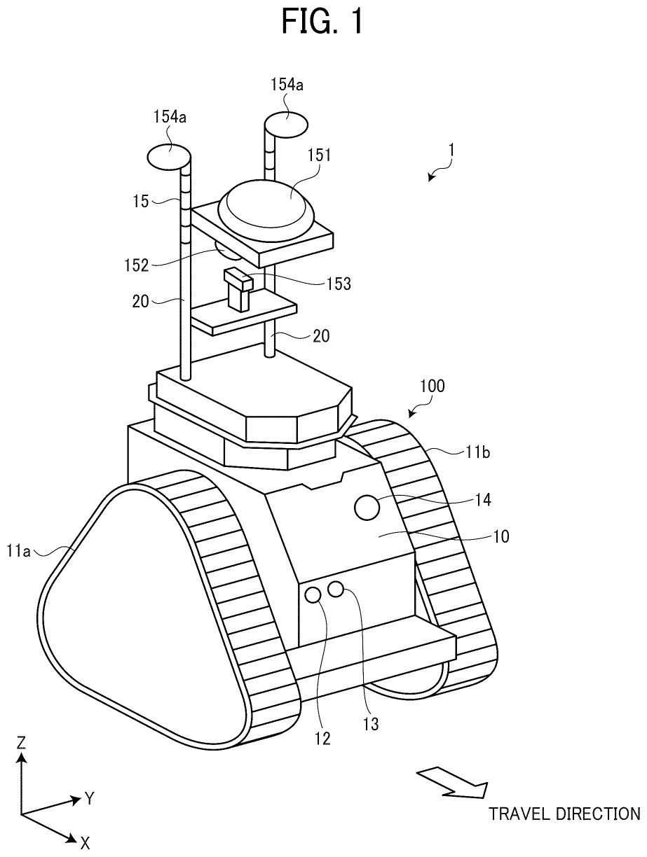

FIG. 1 is an exterior perspective view of a mobile apparatus 1. In the present specification, the Y direction matches the lateral width direction of the mobile apparatus 1. The X direction matches the travel direction (advancing direction) of the mobile apparatus 1, and the Z direction matches the height direction of the mobile apparatus 1.

The mobile apparatus 1 includes crawler mobile bodies 11a and 11b and a main body 10. The crawler mobile bodies 11a and 11b and the main body 10 form a mobile platform 100.

The crawler mobile bodies 11a and 11b are units serving as drivers of the mobile apparatus 1. Each of the crawler mobile bodies 11a and 11b employs a crawler belt that is a metallic or rubber belt.

The crawler mobile bodies 11a and 11b have a wider contact area with the ground compared to mobile vehicles that travel with tires, such as automobiles, and can travel more stably even in, for example, a bad footing environment.

While the mobile vehicle that travels with tires requires space to make a turn, the mobile apparatus 1 equipped with crawler mobile bodies 11a and 11b can perform a so-called spot turn (turning about the center point between the two crawler mobile bodies 11a and 11b) or a so-called pivot turn (pivoting about one of the crawler mobile bodies). Accordingly, the mobile apparatus 1 can smoothly turn even in a limited space. The mobile apparatus 1 is not limited to an apparatus that performs both a spot turn and a pivot turn, but may be an apparatus that performs at least one of spot turn and pivot turn. Spot turn and pivot turn are examples of turning.

In this disclosure, spot turn refers to turning on the spot with the center of the vehicle body as an axis by rotating the left and right crawler belts in opposite directions at a constant speed. Such a turn is also called a spin turn. Additionally, pivot turn refers to rotating only one crawler belt with the other crawler belt kept stopped, using the stopped crawler belt as the axis for the turn.

The two crawler mobile bodies 11a and 11b are installed across the main body 10 such that the mobile apparatus 1 can travel. The number of crawler mobile bodies is not limited to two and may be three or more. For example, the mobile apparatus 1 may include three crawler mobile bodies arranged in parallel, such that the mobile apparatus 1 can travel. Alternatively, the mobile apparatus 1 may include four crawler mobile bodies arranged on the front, rear, right, and left sides like the tires of an automobile.

The crawler mobile bodies 11a and 11b each have a substantially triangular shape. The crawler mobile bodies 11a and 11b may be collectively referred to as the crawler mobile bodies 11″ in the following description. The substantially triangular crawler mobile bodies 11 are advantageous in that, when a constraint is imposed on the length of the traveling body in the front-rear direction, the contact area of the crawler mobile body with the ground is maximized within the constraint. Such a configuration can increase the stability in traveling as described above. In the case of a so-called tank crawler in which the upper side (drive wheel side) is longer than the lower side (road wheel side), when a constraint is imposed on the front-rear direction length, the contact area with the ground is typically small, making traveling unstable. As described above, the crawler mobile bodies 11 are effective in increasing traveling performance, especially when applied to the mobile apparatus 1 that is relatively small.

The main body 10 supports the crawler mobile bodies 11a and 11b to travel and includes a controller to control the driving of the mobile apparatus 1. The main body 10 also includes a battery to supply electric power for driving the crawler mobile bodies 11a and 11b.

The main body 10 of the mobile apparatus 1 includes a power button 12, a start button 13, an emergency stop button 14, a state indicator lamp 15, and columnar supports 20.

The power button 12 is an operation device to be pressed by a person near the mobile apparatus 1 to turn on or off the power of the mobile apparatus 1. The start button 13 is an operation device to be pressed by a person near the mobile apparatus 1 to start the two crawler mobile bodies 11a and 11b. The emergency stop button 14 is an operation device to be pressed by a person near the mobile apparatus 1 to stop the travel of the mobile apparatus 1.

The state indicator lamp 15 is mounted on the support 20. The state indicator lamp 15 is a notification means for indicating the state of the mobile apparatus 1. When the state of the mobile apparatus 1 changes, for example, due to a decrease in the remaining battery charge, the state indicator lamp 15 lights up to notify persons nearby of the state change of the mobile apparatus 1. The state indicator lamp 15 lights up also when a possible abnormality, such as an obstacle to the travel of the mobile apparatus 1, is detected.

Although the mobile apparatus 1 in FIG. 1 includes one state indicator lamp 15, the number of state indicator lamps 15 is not limited thereto and may be two or more. In alternative to or in addition to the state indicator lamp 15, the notification means may include, for example, a speaker to output an alert sound indicating the state of the mobile apparatus 1.

The mobile apparatus 1 includes a range sensor 152 for horizontal detection, which is disposed at a height of 0.5 meter. The range sensor 152 is oriented in the travel direction of the main body 10. The range sensor 152 for horizontal detection performs detection with laser light and two-dimensional range finding. The range sensor 152 is, for example, a laser range finder (LRF) employing two-dimensional (2D) light detection and ranging (LiDAR). Examples of 2D LiDAR sensors include micro-electro-mechanical systems (MEMS)-based sensors and rotating-mirror sensors.

The range sensor 152 irradiates an object with laser light, measures the time for the laser light to be reflected from the object, and calculates the object's distance and direction based on the measured time. The range sensor 152 has the capability of measuring a 270-degree range with the front X direction as the center.

The mobile apparatus 1 measures the distance to an object in a wide horizontal range using the range sensor 152 and uses the distance as obstacle information.

The mobile apparatus 1 further includes a range sensor 153 for oblique direction detection. The range sensor 153 is disposed at a height of 0.9 meter and a depression angle of 30 degrees, with the travel direction of the main body 10 defined as the front. This installation position is determined to enable the detection of the traveling road surface up to the front side of the mobile apparatus 1. The range sensor 153 for oblique direction detection is, for example, an LRF employing a three-dimensional (3D) LiDAR to perform three-dimensional range finding. Examples of 3D LiDAR sensors include MEMS-based sensors and rotating-mirror sensors.

As the 3D LiDAR sensor, a non-repetitive scanning sensor that measures a conical range of 70.4 degrees as viewed from the center of the sensor detection surface and measures the distance up to 90 meters is used. The non-repetitive scanning method is scanning in a flower-like pattern while shifting the phase little by little in the horizontal and vertical directions, and is characterized in that the point cloud coverage in the measurement range is increased by the accumulation of time. The range sensor 153 is installed at an angle inclined down from the horizontal surface so as to be inclined down by a predetermined angle relative to a horizontal road surface.

The range sensor 153 irradiates an object, such as an obstacle on the road surface, with laser light, measures the distance to the object and the direction of the object based on the time for the laser light to be reflected from the object, and obtains the result of measurement as data. For the installation position of the range sensor 153, the appropriate value depends on the widths and lengths of the crawler belts of the crawler mobile bodies 11a and 11b, and the sizes, widths, depths, and heights of objects to be detected.

The mobile apparatus 1 further includes a camera 151, with the travel direction of the main body 10 defined as the front. Examples of the camera 151 include a spherical camera, a stereo camera, and an infrared camera. As illustrated in FIG. 1, the camera 151 is located above the main body 10, and is attached to an upper portion of the mobile apparatus 1 at a distance from the main body 10 through the support 20.

The camera 151 may be attached to the main body 10 without a distance therefrom. However, such a position of the camera 151 is inevitably too low for observation at human eye level, and prevents the camera from achieving human-equivalent observation performance. The camera 151 is disposed at the upper position through the support 20 to be closer to the human eye level. However, such a placement shifts the center of gravity of the entire mobile apparatus 1 upward because the heavy object is disposed at the upper position. Then, stability decreases. In view of this, the camera 151 is positioned considering the balance in the front-rear direction with respect to the main body 10 and the portions, such as the crawler mobile bodies 11a and 11b, related to traveling or processing. That is, the camera 151 is positioned so that the center of gravity is located at the center in the front-rear direction to keep the stability.

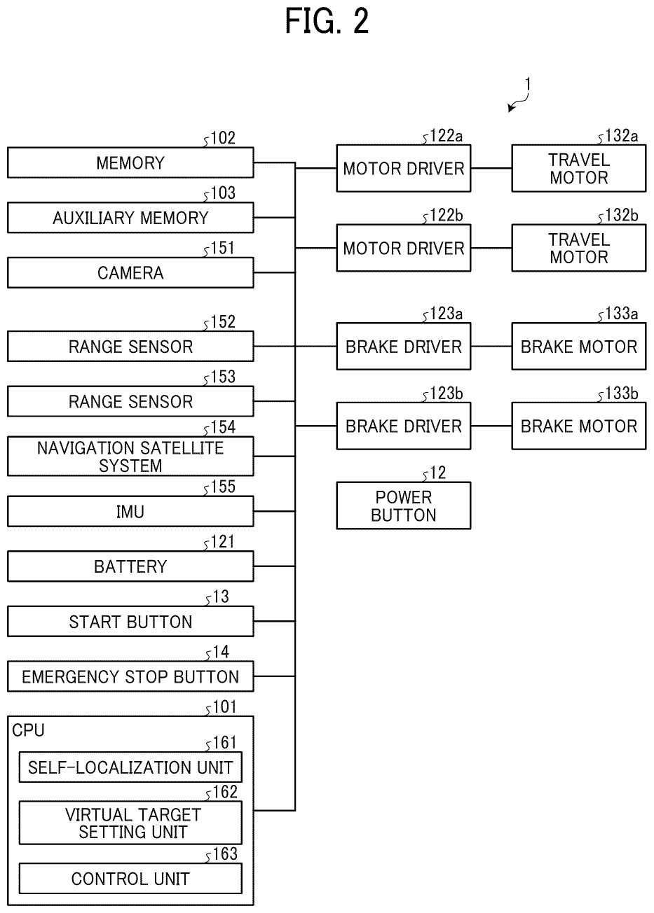

A hardware configuration of the mobile apparatus 1 is described below. FIG. 2 is a block diagram illustrating a hardware configuration of the mobile apparatus 1.

As illustrated in FIG. 2, the mobile apparatus 1 includes a central processing unit (CPU) 101, a memory 102, an auxiliary memory 103, a camera 151, the range sensors 152 and 153, a navigation satellite system 154, an inertial measurement unit (IMU) 155, a battery 121, motor drivers 122a and 122b (left and right), travel motors 132a and 132b (left and right), brake drivers 123a and 123b (left and right), brake motors 133a and 133b (left and right), a power button 12, a start button 13, and an emergency stop button 14.

The CPU 101 controls the entire operation of the mobile apparatus 1. The memory 102 is a temporary storage area for the operation of the CPU 101, such as the execution of programs. The auxiliary memory 103 stores data, such as the program executed by the CPU 101.

The CPU 101 operates according to the program stored in the memory 102 to control the mobile apparatus 1 to autonomously travel using an obstacle map.

The program to be executed on the mobile apparatus 1 may be a file installable or executable by a computer and stored on a computer-readable recording medium, such as a compact disc-read-only memory (CD-ROM), a flexible disk (FD), a compact disc-recordable (CD-R), or a digital versatile disk (DVD).

The program to be executed on the mobile apparatus 1 may be stored on a computer connected to a network such as the Internet and may be downloaded through the network from the computer. Alternatively, the program executed on the mobile apparatus 1 may be provided or distributed via a network such as the Internet. Further, the program executed on the mobile apparatus 1 may be preloaded in, for example, the read-only memory (ROM).

The motor drivers 122a and 122b (collectively “motor drivers 122”) are drivers for the travel motors 132a and 132b (collectively “travel motors 132”) included in the two crawler mobile bodies 11a and 11b, respectively. The brake drivers 123a and 123b (collectively “brake drivers 123”) are drivers for the brake motors 133a and 133b (collectively “brake motors 133”) included in the two crawler mobile bodies 11a and 11b, respectively.

The motor drivers 122 and the brake drivers 123 receive commands from the CPU 101 to control the travel motors 132 and the brake motors 133, respectively.

The power button 12 is a switch that turns on or off the power of the mobile apparatus 1. The power button 12 operates in conjunction with the pressing of the power button 12 (see FIG. 1). The start button 13 is a switch for starting the crawler mobile bodies 11a and 11b. The start button 13 operates in conjunction with the pressing of the start button 13 (see FIG. 1). The emergency stop button 14 is a switch for stopping the crawler mobile bodies 11a and 11b in an emergency. The emergency stop button 14 operates in conjunction with pressing of the emergency stop button 14 (see FIG. 1).

As described above, the range sensor 152 is an LRF for detecting a horizontal direction and is a 2D LiDAR sensor. As described above, the range sensor 153 is an LRF for oblique direction detection and is a 3D LiDAR sensor.

The navigation satellite system 154 receives radio waves from a satellite and measures the position of the mobile apparatus 1 on the earth based on the received result. The navigation satellite system 154 uses a Real Time Kinematic (RTK)-Global Navigation Satellite System (GNSS).

In the position determination (localization) using RTK-GNSS positioning, when a high-accuracy positioning solution (Fix solution) in the RTK-GNSS positioning is obtained, high accuracy with an error of about several centimeters is achieved.

The navigation satellite system 154 includes two antennas 154a illustrated in FIG. 1 for GNSS reception. The navigation satellite system 154 determines that the reliability (accuracy) of the position information is low when the two pieces of position information obtained by the above-mentioned two antennas 154a differ by a certain distance or greater.

The IMU 155 includes a triaxial accelerometer and an angular velocity sensor (gyroscope). The mobile apparatus 1 detects the tilt amount of the main body 10 of the mobile apparatus 1 using the measurement data of the IMU 155 and corrects the height difference relative to the traveling road surface measured by the range sensor 153 based on the tilt amount of the mobile apparatus 1.

The IMU 155 is preferably disposed near the range sensor 153. When the range sensor 153 is mounted on the main body 10 via an arm, the IMU 155 is preferably mounted on the arm. The IMU 155 also serves as an IMU for self-localization for determining the direction of the mobile apparatus 1. This configuration can eliminate the inconvenience that the height position detected by the range sensor 153 changed by the front-rear shaking of the main body 10 traveling on the rough ground.

Characteristic functions exhibited by the mobile apparatus 1 will be described below.

The mobile apparatus 1 has the following features when the mobile apparatus 1 autonomously travels along the reference path (the path set by the user) represented by a polyline that sequentially connects multiple waypoints.
1) Position a virtual target to be followed by the mobile apparatus 1 on the reference path.
2) In a case that the degree of bending at a certain waypoint is gentle, position the virtual target ahead of the waypoint to achieve smooth traveling.
3) In a case that the degree of bending at a certain waypoint is steep (e.g., in a turn-back path), the virtual target is kept near the waypoint until the mobile apparatus 1 reaches the waypoint, to prevent the mobile apparatus 1 from turning back before reaching the waypoint.

When a mobile apparatus autonomously follows a reference path set in advance, having a sudden direction change or a turning point, it is difficult for the mobile apparatus to reach a desired position on the reference path depending on the degree of bending of the reference path.

In view of this, the mobile apparatus 1 adjusts the virtual target position according to the degree of bending of the reference path. The features of the mobile apparatus 1 will be described in detail below.

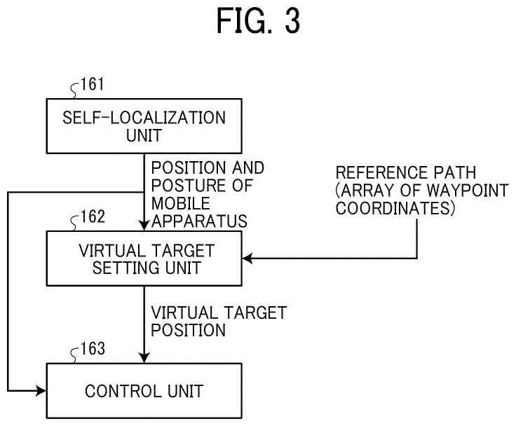

FIG. 3 is a block diagram illustrating a functional configuration of the mobile apparatus 1. The CPU 101 of the mobile apparatus 1 operates according to a program stored in the memory 102 to function as a self-localization unit 161, a virtual target setting unit 162, and a control unit 163. Thus, the CPU 101 serves as the autonomous travel controller.

The self-localization unit 161 determines the position (x, y) and a heading θ of the mobile platform 100 with respect to the reference path composed of line segments connecting multiple, successive waypoints. The lines segments connect successive waypoints.

The virtual target setting unit 162 sets a virtual target to be followed by the mobile platform 100 on the reference path based on the position of the mobile platform 100 and the reference path. More specifically, the virtual target setting unit 162 sets the virtual target ahead of the waypoint when the degree of bending at the waypoint is equal to or greater than a threshold, and sets the virtual target near the waypoint until the mobile platform 100 reaches the waypoint when the degree of bending at the waypoint is smaller than the threshold. In the present specification, the term “near” refers to a region in which the maximum value of the respective shortest distances (the degrees of bending B in FIG. 6) of the waypoints located between the reference point and the virtual target, measured with respect to the line segment connecting the reference point and the virtual target, is below a threshold B_{MAX}. Accordingly, the “near” denotes a region that is objectively determined by the evaluation expression for the degrees of bending. By positioning the virtual target within this region, the mobile platform can be reliably guided to the desired point. The term “setting a virtual target” means adding a virtual target at the position to be followed by the mobile platform 100 on the reference path.

The control unit 163 calculates a control input for following the virtual target according to the position and heading (x, y, θ) of the mobile platform 100 and the position (x_{tgt}, y_{tgt}) of the virtual target, and controls the mobile platform 100 to move to the virtual target.

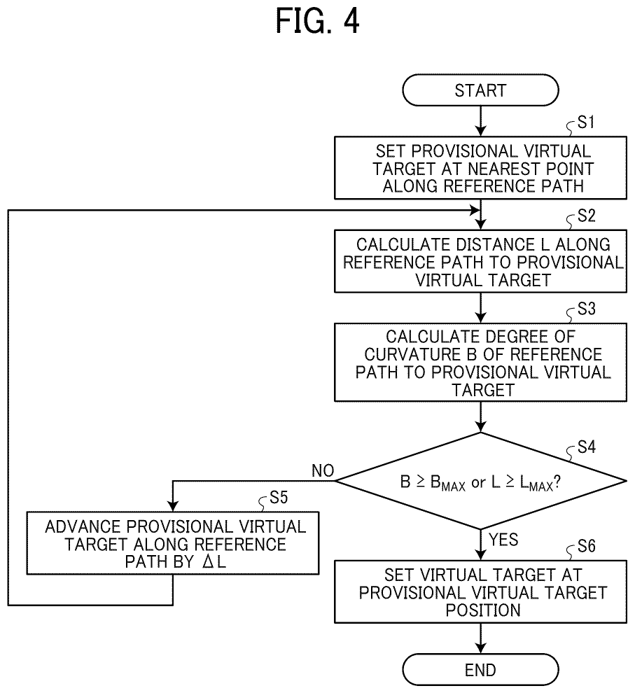

A process performed by the virtual target setting unit 162 will be described below. FIG. 4 is a flowchart of a process performed by the virtual target setting unit 162.

In step S1, the virtual target setting unit 162 positions the starting point as a provisional virtual target at the nearest point on the reference path. In step S2, the virtual target setting unit 162 calculates a length L to the provisional virtual target along the reference path.

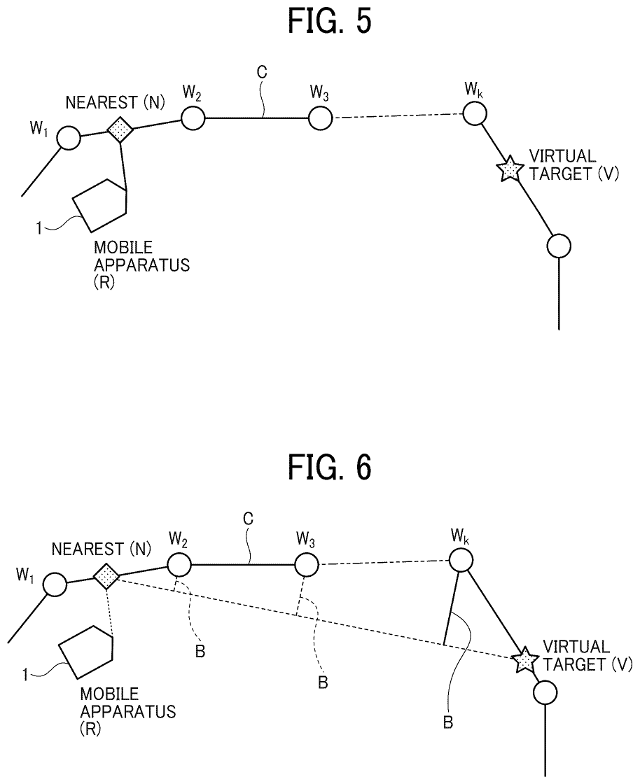

FIG. 5 is a diagram illustrating a method for calculating a distance along a reference path.

As illustrated in FIG. 5, waypoints Wᵢ (W₁, W₂, W₃, . . . , Wₖ) define a reference path C. The waypoints are at distances ΔL. A starting point N is the nearest point to the mobile apparatus 1 on a line segment (W₁W₂) connecting the next waypoint (W₂ in FIG. 5) and the previous waypoint (W₁ in FIG. 5).

The virtual target setting unit 162 according to the present embodiment advances the provisional virtual target by a distance ΔL along the reference path C. In the first time, the distance from the mobile apparatus 1 to the starting point N is calculated and set as the distance L.

The distance L to a virtual target V along the reference path C is the length of polyline when the mobile apparatus 1, the starting point N, the waypoints Wᵢ (W₁, W₂, W₃, . . . , Wₖ), and the virtual target V are connected in order. The mobile apparatus 1 is located at a position R in FIG. 5.

In FIG. 5, the distance L from the mobile apparatus 1 to the virtual target V along the reference path C is expressed by the following expression.

$$L = Dist ( R , N ) + Dist ( N , {W}_{2} ) + Dist ( {W}_{2} , {W}_{3} ) + … + Dist ( {W}_{k - 1} , {W}_{k} ) + Dist ( {W}_{k} , V ) \qquad Expression 1$$

where Dist (R, N) represents a linear distance between the position R of the mobile apparatus 1 and the starting point N.

In step S3, the virtual target setting unit 162 calculates the degree of bending B of the reference path to the provisional virtual target.

FIG. 6 is a diagram illustrating the calculation of the degree of bending of the reference path to the virtual target. As illustrated in FIG. 6, the degree of bending B of the reference path C to the virtual target V is the maximum of the shortest distance Dist (Wᵢ, NV) from each waypoint Wᵢ (W₁, W₂, W₃, . . . , Wₖ), located between the starting point N and the virtual target V, to a connecting line segment NV. The connecting line segment NV is the straight line connecting the starting point N with the virtual target V. The greater the degree of bending B, the steeper the degree of bending.

In FIG. 6, the degree of bending B of the reference path C to the virtual target Vis expressed by the following expression.

$$B = {max}_{2 \leq i \leq k} Dist ( {W}_{i} , \overline{NV} ) \qquad Expression 2$$

In step S4, the virtual target setting unit 162 determines whether the degree of bending B of the reference path C to the provisional virtual target is equal to or greater than the threshold B_{MAX}, or whether the length L along the reference path C to the provisional virtual target is equal to or greater than a predetermined threshold L_{MAX}. The threshold B_{MAX} and the threshold L_{MAX} are design parameters determined in advance as described above.

When the virtual target setting unit 162 determines that the degree of bending B of the reference path to the provisional virtual target is not equal to or greater than the threshold B_{MAX} and the length L along the reference path C to the provisional virtual target is not equal to or greater than the threshold L_{MAX} (No in step S4), in step S5, the virtual target setting unit 162 advances the provisional virtual target by the distance ΔL along the reference path C. Then, the virtual target setting unit 162 returns to step S2, and repeats the process.

By contrast, when the virtual target setting unit 162 determines that the degree of bending B of the reference path C to the provisional virtual target is equal to or greater than the threshold B_{MAX} or that the length L along the reference path C to the provisional virtual target is equal to or greater than the threshold L_{MAX} (Yes in step S4), in step S6, the virtual target setting unit 162 positions the virtual target at the position of the provisional virtual target.

That is, the virtual target setting unit 162 of the mobile apparatus 1 positions the virtual target ahead of the waypoint when the degree of bending at the waypoint is gentle, and keeps the virtual target near the waypoint until the mobile apparatus 1 reaches the waypoint when the degree of bending at the waypoint is steep. When there is a reference path C that turns back at an acute angle, the threshold B_{MAX} is set to be sufficiently small. Thus, the virtual target is kept near the turning point due to the restriction that the degree of bending B is smaller than the threshold B_{MAX} (B<B_{MAX}) in the outward path. When the mobile apparatus 1 sufficiently approaches the turning point, the restriction (B<B_{MAX}) is cleared, and the virtual target proceeds to the return path.

As described above, the virtual target setting unit 162 evaluates the degree of bending of the reference path C to the virtual target using the maximum of the shortest distance from each waypoint to the line segment connecting the virtual target with the mobile platform 100 or the nearest point on the reference path C. When evaluation is performed using, for example, the bending angle, the operation may not be appropriately performed in a case where the adjacent waypoints are very close to each other. By contrast, the above-described method allows the operation to be stably performed regardless of the manner of placing the waypoints.

When the distance ΔL between the waypoints is sufficiently small, the virtual target V is moved substantially continuously on the reference path C. In FIGS. 5 and 6, the provisional virtual target is advanced little by little for the sake of easy understanding. When the distance ΔL between the waypoints is set to a large value and B≥B_{MAX} is satisfied, the speedup of the calculation of the virtual target position is achieved by searching for the position where B<B_{MAX} is satisfied between the provisional virtual target one step before and the current provisional virtual target using, for example, a binary search algorithm.

As described above, the virtual target setting unit 162 continuously moves the virtual target on the reference path, and positions the virtual target as far forward as possible without exceeding the upper limit of the degree of bending of the reference path to the virtual target and without exceeding the upper limit of the distance to the virtual target. As a result, the virtual target continuously moves in accordance with the traveling of the mobile apparatus 1. Thus, the travel control is stabilized.

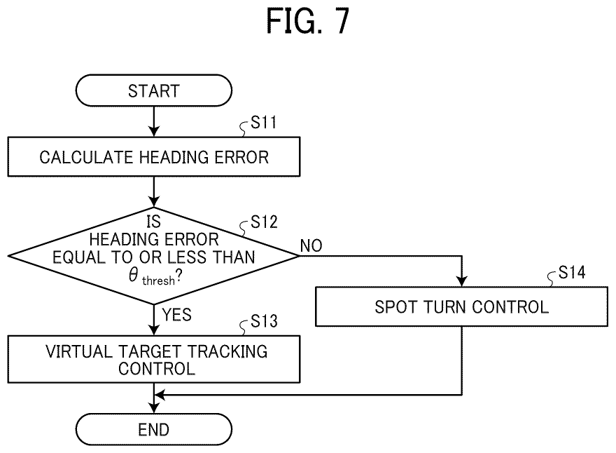

A process performed by the control unit 163 will be described below. FIG. 7 is a flowchart of the process performed by the control unit 163.

In step S11, the control unit 163 calculates a heading error (direction error) θₑᵣᵣₒᵣ. The heading error θₑᵣᵣₒᵣ is the difference between the heading θ of the mobile apparatus 1 and the direction from the position (x, y) of the mobile apparatus 1 to the virtual target position (x_{tgt}, y_{tgt}), and is defined by the following expression.

$${θ}_{error} = \vert arc tan ( \frac{{y}_{tgt} - y}{{x}_{tgt} - x} ) - θ \vert \qquad Expression 3$$

In step S12, the control unit 163 determines whether the heading error calculated in step S11 is equal to or less than the thresholds θₜₕᵣₑₛₕ. The threshold θₜₕᵣₑₛₕ is a design parameter.

When determining that the heading error calculated in step S11 is equal to or less than the threshold θₜₕᵣₑₛₕ (Yes in step S12), in step S13, the control unit 163 performs virtual target following control.

The virtual target following control may be performed according to the following control rules. In the description below, the control unit 163 calculates a straight traveling speed v and a turning angular velocity ω in the virtual target following control.

$$v = {{K}_{1} ( {( {x}_{tgt} - x )}^{2} - {( {y}_{tgt} - y )}^{2} )}^{- \frac{1}{2}} \qquad Expression 4$$

$$ω = {K}_{2} ( arc tan ( \frac{{y}_{tgt} - y}{{x}_{tgt} - x} ) - θ )$$

where K₁ and K₂ (>0) are control gains and are design parameters.

By contrast, when determining that the heading error calculated in step S11 is not equal to or less than the thresholds θₜₕᵣₑₛₕ (No in step S12), in step S14, the control unit 163 controls the mobile apparatus 1 to perform a spot turn. That is, the control unit 163 controls the spot turn when the virtual target is greatly deviated from the front of the mobile platform 100 of the mobile apparatus 1. This control allows the mobile apparatus 1 to turn back at a turning radius of 0 with respect to the reference path that turns back at an acute angle.

Specifically, the following control rules are conceivable for the spot turn control. The control unit 163 calculates the straight traveling speed v and the turning angular velocity ω in the spot turn control.

$$v = 0 \qquad Expression 5$$

$$ω = sign ( arc tan ( \frac{{y}_{tgt} - y}{{x}_{tgt} - x} ) - θ ) {ω}_{spin}$$

where ωₛₚᵢₙ (>0) is a design parameter at a fixed turning angular velocity, and sign is a function for extracting the reference sign.

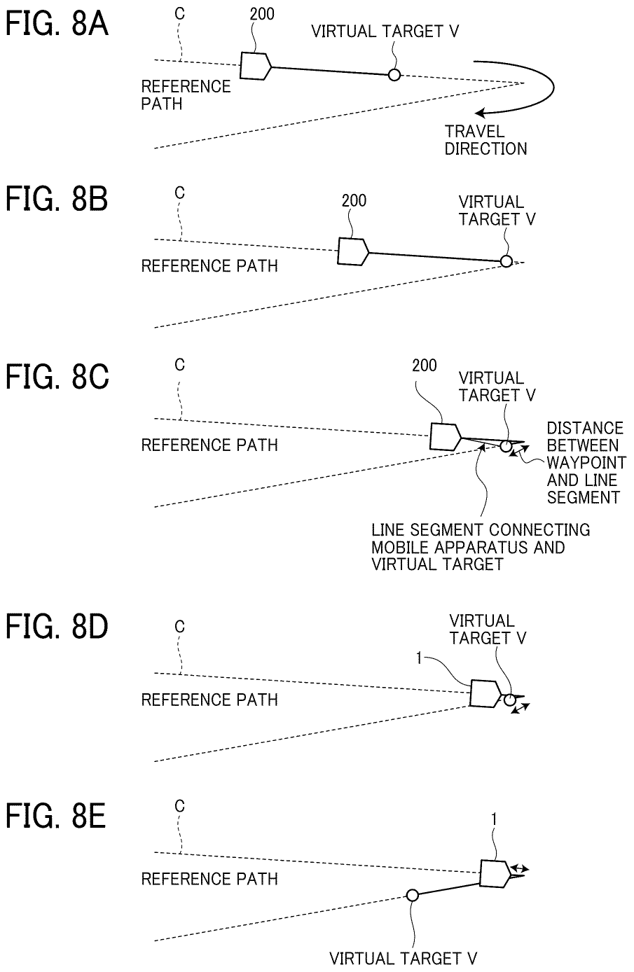

Effects of the mobile apparatus 1 will be described below. FIGS. 8A to 8E are diagrams illustrating the effects of the mobile apparatus 1. The reference path C illustrated in FIGS. 8A to 8E includes an acute-angle turning point.

FIGS. 8A to 8C are diagrams illustrating a travel control of a mobile apparatus 200 according to a comparative example. The mobile apparatus 200 positions a virtual target on the reference path C such that the distance (along the straight line or the reference path C) from the mobile apparatus 200 to the virtual target is constant. Accordingly, when the mobile apparatus 200 approaches the turning point, the virtual target is positioned on the return path of the reference path C as illustrated in FIG. 8C. In this case, if the mobile apparatus 200 controls the travel to follow the virtual target, the mobile apparatus 200 fails to reach the turning point.

By contrast, as illustrated in FIGS. 8D and 8E, the mobile apparatus 1 according to the above-described embodiments positions the virtual target such that the distance from the virtual target to the line segment connecting the mobile apparatus 1 and the virtual target does not increase. Thus, the virtual target remains near the turning point even when the mobile apparatus 1 approaches the turning point. Therefore, the mobile apparatus 1 can reach the turning point. Further, when the mobile apparatus 1 sufficiently approaches the turning point, the virtual target is moved on the return path. Thus, the mobile apparatus 1 can start the turning operation.

As described above, even when the reference path includes an acute turning point, the mobile apparatus 1 according to the above-described embodiments can reliably reach the turning point and turn back at the turning point. In the comparative example, the travel control may become unstable because the virtual target is discretely moved. By contrast, the mobile apparatus 1 according to the above-described embodiments achieves stable travel control.

The above-described mobile platform 100 of the mobile apparatus 1 employs caterpillar traveling. However, the shape and the traveling method of the mobile apparatus 1 are not limited to those illustrated in FIG. 1. The aspects of the mobile apparatus 1 may be applied to, for example, a bipedal walking robot, a multi-pedal walking robot, a drone, a flying device, or an underwater mobile apparatus. For example, the mobile platform 100 may be an automobile.

The description above concerns the autonomous travel control method for the mobile platform 100, including the small-sized crawler mobile bodies 11a and 11b, assumed to be used for inspection in facilities such as a factory. However, the autonomous travel control method for the mobile platform 100 can be applied to, for example, “automatic driving of an automobile.” Specifically, when an automobile is automatically driven on a road having successive sharp curves, the automobile cannot move along the road unless the automobile reaches a turning point. Thus, the technique described above can be applied to the automatic driving of the automobile.

The autonomous travel controller may be connected to the mobile platform 100 via a network. That is, the autonomous travel controller may be an information processing apparatus, such as a server, and may transmit control information to the mobile platform 100, such as an automobile, via the server.

One aspect of the present disclosure concerns a program which, when executed by a computer, causes the computer to perform a method for controlling a mobile apparatus to autonomously travel following a reference path including line segments connecting successive waypoints. The method includes determining a position and a heading of a mobile apparatus with respect to the reference path; setting a virtual target on the reference path based on the position of the mobile apparatus and the reference path; calculating a degree of bending of the reference path at one waypoint of the successive waypoints; positioning the virtual target ahead of the one waypoint in a case that the degree of bending at the one waypoint is equal to or greater than a threshold; positioning the virtual target near the one waypoint until the mobile apparatus reaches the one waypoint in a case that the degree of bending at the one waypoint is smaller than the threshold; and controlling the mobile apparatus to follow the virtual target based on the position and the heading of the mobile apparatus and a position of the virtual target.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An autonomous travel controller comprising
circuitry configured to:
determine a position and a heading of a mobile apparatus with respect to a reference path, the reference path including line segments connecting successive waypoints;
set a virtual target on the reference path based on the position of the mobile apparatus and the reference path;
calculate a degree of bending of the reference path at one waypoint of the successive waypoints;
position the virtual target ahead of the one waypoint in a case that the degree of bending at the one waypoint is equal to or greater than a threshold;
position the virtual target near the one waypoint until the mobile apparatus reaches the one waypoint in a case that the degree of bending at the one waypoint is smaller than the threshold; and
control the mobile apparatus to follow the virtual target based on the position and the heading of the mobile apparatus and a position of the virtual target.

2. The autonomous travel controller according to claim 1,
wherein the circuitry is configured to:
continuously move the virtual target on the reference path; and
in the case that the degree of bending at the one waypoint is equal to or greater than the threshold, position the virtual target as far forward as possible without exceeding an upper limit of the degree of bending of the reference path to the virtual target and an upper limit of a distance to the virtual target.

3. The autonomous travel controller according to claim 2,
wherein the circuitry is configured to evaluate the degree of bending of the reference path to the virtual target using a maximum of a shortest distance from each waypoint to a connecting line segment, the connecting line segment connecting the virtual target and the mobile apparatus or a nearest point on the reference path.

4. The autonomous travel controller according to claim 1,
wherein the circuitry is configured to control the mobile apparatus to perform a spot turn in a case that the virtual target is deviated from a front of the mobile apparatus.

5. A mobile apparatus comprising
circuitry configured to:
determine a position and a heading of the mobile apparatus with respect to a reference path, the reference path including line segments connecting successive waypoints;
set a virtual target on the reference path based on the position of the mobile apparatus and the reference path;
calculate a degree of bending of the reference path at one waypoint of the successive waypoints;
position the virtual target ahead of the one waypoint in a case that the degree of bending at the one waypoint is equal to or greater than a threshold;
position the virtual target near the one waypoint until the mobile apparatus reaches the one waypoint in a case that the degree of bending at the one waypoint is smaller than the threshold; and
control the mobile apparatus to follow the virtual target based on the position and the heading of the mobile apparatus and a position of the virtual target.

6. An autonomous travel control method comprising:
determining a position and a heading of a mobile apparatus with respect to a reference path, the reference path including line segments connecting successive waypoints;
setting a virtual target on the reference path based on the position of the mobile apparatus and the reference path;
calculating a degree of bending of the reference path at one waypoint of the successive waypoints;
positioning the virtual target ahead of the one waypoint in a case that the degree of bending at the one waypoint is equal to or greater than a threshold;
positioning the virtual target near the one waypoint until the mobile apparatus reaches the one waypoint in a case that the degree of bending at the one waypoint is smaller than the threshold; and
controlling the mobile apparatus to follow the virtual target based on the position and the heading of the mobile apparatus and a position of the virtual target.
